(19) United States
(12) Patent Application Publication
(10) Pub. No.: US 2026/0268647 A1
(43) Pub. Date: Sep. 10, 2026

(54) TRAINING DEVICE, TRAINING METHOD, AND RECORDING MEDIUM

(71) Applicant: NEC Corporation, Tokyo (JP)

(72) Inventors: Ryosuke SAKAI, Tokyo (JP); Soma SHRAISHI, Tokyo (JP); Tomokazu KANEKO, Tokyo (JP)

(73) Assignee: NEC Corporation, Tokyo (JP)

(21) Appl. No.: 19/168,339

(22) PCT Filed: Mar. 29, 2023
(86) PCT No.: PCT/JP2023/012875

§ 371 Date: Sep. 24, 2025

(51) Int. Cl. G06V 10/82

(52) U.S. Cl. CPC G06V 10/82; G06V 2201/034

(57) ABSTRACT

In a training device, the model acquisition means acquires a first prediction model that generates a first prediction feature amount indicating a state of each object at a next time based on an input object feature amount, and a second prediction model that generates a second prediction feature amount indicating a state of each object at the next time based on the input object feature amount and an image at the next time. The identification model training means trains an identification model that identifies an output from the first prediction model and an output from the second prediction model. The retraining means retrains the first prediction model in such a way that accuracy of the identification by the identification model decreases.

### TECHNICAL FIELD

The present disclosure relates to a technology of predicting a future temporal transition of an object in an image.

### BACKGROUND ART

A world model is known as a technology of acquiring representation of individual objects from images without any teacher such as positions of the objects or labels and predicting future temporal transitions. Patent Document 1 discloses a technology of performing robot learning by combining imitation learning and reinforcement learning while acquiring the world model through an expert and predicting the future.

### PRECEDING TECHNICAL REFERENCES

### Patent Document

Patent Document 1: Japanese Patent Application Laid-Open under No. JP 2021-192141

### SUMMARY

### Problem to be Solved

In a case where a model that predicts a temporal transition of an object in a moving image is trained, moving images for training are used. However, performance of the model is evaluated only based on differences from the moving images for training. Therefore, in a case where the trained model includes a probabilistic transition in the future, it is not possible to determine likelihood of a result caused by the transition.

One object of the present disclosure is to train a prediction model capable of predicting a likely temporal transition without being too caught by a moving image for training.

### Means for Solving the Problem

According to an example aspect of the present invention, there is provided a training device comprising:
model acquisition means configured to acquire a first prediction model that generates a first prediction feature amount indicating a state of each object at a next time based on an input object feature amount, and a second prediction model that generates a second prediction feature amount indicating a state of each object at the next time based on the input object feature amount and an image at the next time;
identification model training means configured to train an identification model that identifies an output from the first prediction model and an output from the second prediction model; and
retraining means configured to retrain the first prediction model in such a way that accuracy of the identification by the identification model decreases.

According to another example aspect of the present invention, there is provided a training method executed by a computer, comprising:
acquiring a first prediction model that generates a first prediction feature amount indicating a state of each object at a next time based on an input object feature amount, and a second prediction model that generates a second prediction feature amount indicating a state of each object at the next time based on the input object feature amount and an image at the next time;
training an identification model that identifies an output from the first prediction model and an output from the second prediction model; and
retraining the first prediction model in such a way that accuracy of the identification by the identification model decreases.

According to still another example aspect of the present invention, there is provided a recording medium recording a program for causing a computer to execute processing comprising:
acquiring a first prediction model that generates a first prediction feature amount indicating a state of each object at a next time based on an input object feature amount, and a second prediction model that generates a second prediction feature amount indicating a state of each object at the next time based on the input object feature amount and an image at the next time;
training an identification model that identifies an output from the first prediction model and an output from the second prediction model; and retraining the first prediction model in such a way that accuracy of the identification by the identification model decreases.

### BRIEF DESCRIPTION OF THE DRAWINGS

FIG. 1 illustrates a concept of a training device according to a first example embodiment.

FIG. 2 is a block diagram illustrating a hardware configuration of the training device.

FIG. 3 is a block diagram illustrating a functional configuration of the training device for executing a first training step.

FIG. 4 is a block diagram illustrating a functional configuration of the training device for executing a second training step.

FIG. 5 is a block diagram illustrating a functional configuration of the training device for executing a third training step.

FIG. 6 is a main routine of training processing by the training device.

FIG. 7 is a flowchart of the training processing of a transition model and an inference model.

FIG. 8 is a flowchart of the training processing of an identification model.

FIG. 9 is a flowchart of the training processing of the transition model.

FIG. 10 schematically illustrates an example of future prediction using the transition model and the inference model.

FIG. 11 illustrates a training method of the identification model according to a first modification.

FIG. 12 is a block diagram illustrating a configuration of a training device according to a second example embodiment.

FIG. 13 is a flowchart of processing by the training device according to the second example embodiment.

### EXAMPLE EMBODIMENTS

Hereinafter, preferred example embodiments of the present disclosure will be described with reference to the drawings.

### First Example Embodiment

### Concept of Training Device

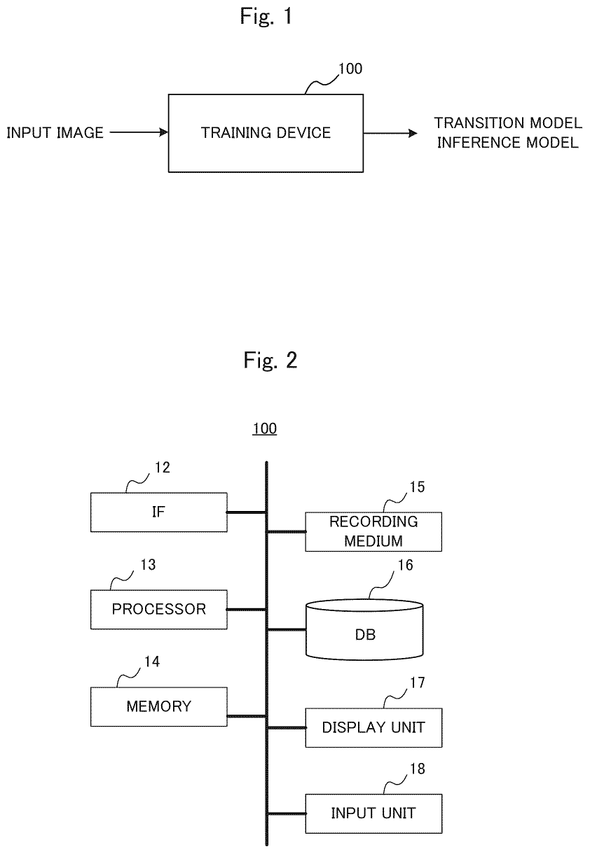

FIG. 1 illustrates a concept of a training device according to a first example embodiment. A training device 100 trains a prediction model that predicts future temporal transitions of objects included in an input image. Such a prediction model is also referred to as a world model. For example, in a case where the input image is obtained by capturing an environment in which a robot arm moves an object, the prediction model acquires representation of objects included in the input image and predicts future temporal transitions of the objects. In the above example, the objects to be predicted include the robot arm itself, the object to be moved by the robot arm, a fixed object disposed in the captured environment, and the like.

In the present example embodiment, the training device 100 basically trains the prediction model by the following three training steps.

### (1) First Training Step

The training device 100 trains two prediction models as models that predict future temporal transitions of objects. A first prediction model is a model (hereinafter, also referred to as a “transition model”) that outputs a first object feature amount indicating a state of each object at a next time based on an input object feature amount of each object. A second prediction model is a model (hereinafter, also referred to as an “inference model”) that outputs a second object feature amount indicating a state of each object at the next time based on the input object feature amount of each object and an actual image at the next time.

### (2) Second Training Step

The training device 100 trains an identification model that identifies the output from the transition model and the output from the inference model.

### (3) Third Training Step

The training device 100 retrains the transition model in such a way that the identification model cannot identify the output from the transition model and the output from the inference model.

By executing the above training steps, the training device 100 can generate the transition model capable of accurately predicting the future temporal transitions of the objects even when there is no image of the next time. Details of each training step will be described later.

### Hardware Configuration

FIG. 2 is a block diagram illustrating a hardware configuration of the training device 100. As illustrated, the training device 100 includes an interface (IF) 12, a processor 13, a memory 14, a recording medium 15, a database (DB) 16, a display unit 17, and an input unit 18.

The IF 12 acquires an input image from the outside. The input image is a still image or a moving image obtained by capturing a state of an object in a certain environment. The IF 12 outputs a transition model and an inference model obtained by training to the outside.

The processor 13 is a computer such as a central processing unit (CPU), and controls the entire training device 100 by executing a program prepared in advance. As the processor 13, a CPU, a graphics processing unit (GPU), a digital signal processor (DSP), a micro processing unit (MPU), a floating point number processing unit (FPU), a physics processing unit (PPU), a tensor processing unit (TPU), a quantum processor, a microcontroller, a combination of these, or the like can be used. The processor 13 executes training processing to be described later.

The memory 14 includes a read only memory (ROM), a random access memory (RAM), and the like. The memory 14 stores various programs executed by the processor 13. The memory 14 is also used as a work memory during execution of various types of processing by the processor 13.

The recording medium 15 is a non-volatile non-transitory recording medium such as a disk-shaped recording medium or a semiconductor memory, and is attachable to and detachable from the training device 100. The recording medium 15 records various programs executed by the processor 13. When the training device 100 executes various types of processing, a program recorded in the recording medium 15 is loaded into the memory 14 and executed by the processor 13.

The DB 16 stores, as necessary, an input image input through the IF 12 at the time of training. The DB 16 may store an inference model and an identification model generated in a process of the training.

The display unit 17 includes, for example, a liquid crystal display. The input unit 18 includes, for example, a keyboard and a mouse. The display unit 17 and the input unit 18 are used when, for example, an operator of the training device 100 performs a necessary operation input.

### Functional Configuration

### First Training Step

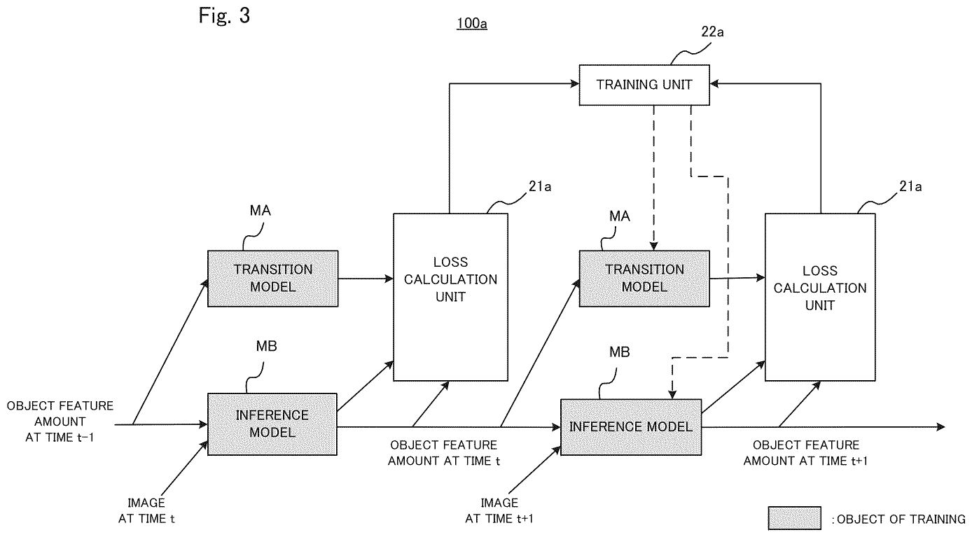

FIG. 3 is a block diagram illustrating a functional configuration of a training device 100a for executing the first training step. In the first training step, the training device 100a includes a loss calculation unit 21a and a training unit 22a. In the first training step, the training device 100a trains a transition model MA and an inference model MB. The transition model MA and the inference model MB are configured by a neural network. Although a plurality of the transition models MA and a plurality of the inference models MB are illustrated in FIG. 3, these are illustrated as the plurality of models for the sake of convenience in order to illustrate processing of another input image, and actually, there are one transition model MA and one inference model MB.

Now, it is assumed that there are time-series input images from a time t−1 to a time t+1. Here, t is a natural number, and a minimum unit between frames of a moving image is 1. A frame rate of the moving image may be an optional value, but a transition may be estimated at intervals of n frames. In that case, for example, transition prediction such as t≥t+n≥t+2n is performed. More generally, transition prediction such as t+s>t+s+n≥t+s+2n can be performed at the time of training using a random integer s (0≤s<n).

In a case where states from the time t−1 to a time t are predicted, an object feature amount of each object at the time t−1 predicted by the inference model MB is input to the transition model MA and the inference model MB. The object feature amount is an object center representation indicating a position, a shape, and the like of each object, and for example, a feature vector can be used. An actual image at the time t is further input to the inference model MB and the loss calculation unit 21a.

The transition model MA predicts a transition of each object based on the input object feature amount at the time t−1, calculates a probability distribution of a state (hereinafter, referred to as a “state distribution”) of the object at the next time t for each object, and outputs the probability distribution to the loss calculation unit 21a. The state distribution of the object can be, for example, a vector including a feature vector indicating the state of the object and a vector indicating the probability distribution of the state of the object. As described above, the “state distribution” represents the state of each object by the probability distribution, and the “object feature amount” is a deterministic state vector sampled based on the state distribution.

The inference model MB calculates, from the input image at the time t, an object feature amount for each object included in the image. The transition model MA also calculates a state distribution of the object at the next time t for each object based on the obtained object feature amount and the image at the time t, and outputs the state distribution to the loss calculation unit 21a.

The state distribution at the time t generated by the transition model MA, the state distribution at the time t generated by the inference model MB, and the actual image at the time t are input to the loss calculation unit 21a. First, the loss calculation unit 21a calculates an inter-distribution distance between the state distribution at the time t generated by the transition model MA and the state distribution at the time t generated by the inference model MB. As the inter-distribution distance, for example, Kullback-Leibler divergence (KL divergence) can be used. The loss calculation unit 21a generates a reconstruction image by reconstructing the image at the time t from the state distribution at the time t generated by the inference model MB, and calculates an error (hereinafter, referred to as a “reconstruction error”) between the reconstruction image and the input actual image at the time t. The loss calculation unit 21a then outputs the calculated inter-distribution distance and the calculated reconstruction error to the training unit 22a.

In an example of the reconstruction error, an image can be represented as a vector of 3×W×H by using RGB (three channels), the number of horizontal pixels W, and the number of height pixels H, and a Euclidean distance between a vector of a correct answer image and a vector of a reconstruction image can be set as the reconstruction error. In another example, a negative value (value with a minus sign) of log likelihood between a probability distribution in which a vector of a correct answer image is an average value and variance of each element is o given in advance and a vector of a reconstruction image can be used as the reconstruction error.

The training device 100a performs similar processing by using the object feature amount at the time t predicted by the inference model MB and an image at the time t+1. That is, the loss calculation unit 21a calculates an inter-distribution distance between a state distribution at the time t+1 generated by the transition model MA and a state distribution at the time t+1 generated by the inference model MB. The loss calculation unit 21a generates a reconstruction image by reconstructing the image at the time t+1 from the state distribution at the time t+1 generated by the inference model MB, and calculates a reconstruction error between the reconstruction image and the input actual image at the time t+1. The loss calculation unit 21a then outputs the calculated inter-distribution distance and the calculated reconstruction error to the training unit 22a.

The training unit 22a then trains the transition model MA and the inference model MB by using, as a loss, a sum total of the inter-distribution distances and the reconstruction errors input from the two loss calculation units 21a. Specifically, the training unit 22a updates parameters of the transition model MA and the inference model MB in such a way that the inter-distribution distances decrease and the reconstruction errors decrease. As a result, the training of the transition model MA and the inference model MB is performed in such a way that the state distribution output from the transition model MA and the state distribution output from the inference model MB are close to each other and the reconstruction image output from the inference model MB and the actual image input to the loss calculation unit 21a are close to each other. Thus, in the first training step, the transition model MA and the inference model MB are trained by using the input images.

As the first training step, a method using ViMON, OP3, G-SWM, GATSBI, or the like known as a world model may be used in addition to the above method.

### Second Training Step

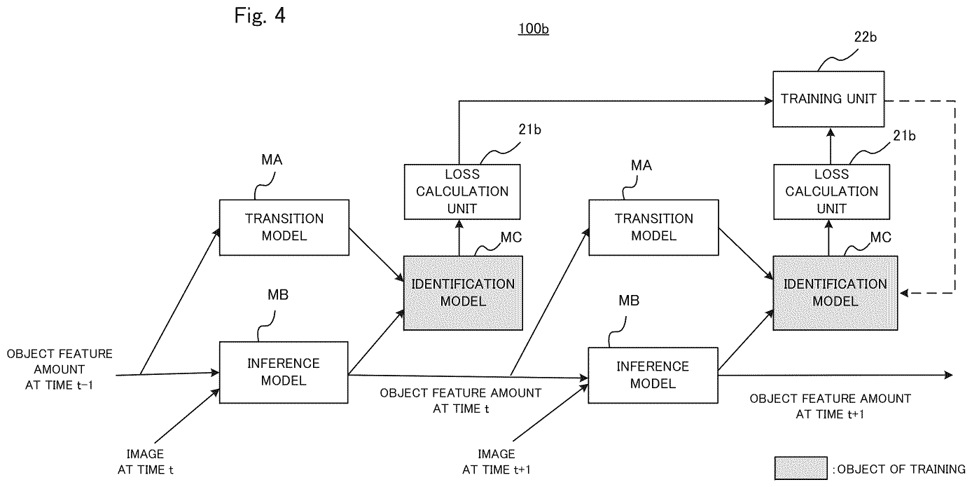

FIG. 4 is a block diagram illustrating a functional configuration of a training device 100b for executing the second training step. In the second training step, the training device 100b trains an identification model MC that identifies an output from the transition model MA and an output from the inference model MB. The identification model MC is configured by a neural network. In the second training step, the training of the identification model MC is performed by using the transition model MA and the inference model MB trained in the first training step. That is, in the second training step, the transition model MA and the inference model MB are not to be trained.

Now, it is assumed that there are the time-series input images from the time t−1 to the time t+1. As illustrated in FIG. 4, the object feature amount of each object at the time t−1 is input to the transition model MA and the inference model MB, and the image at the time t is input to the inference model MB. The transition model MA generates the state distribution at the time t from the object feature amount at the time t−1, reconstructs the image at the time t from the state distribution at the time t, and outputs the image to the identification model MC. The inference model MB generates the state distribution at the time t from the object feature amount at the time t−1 and the actual image at the time t, reconstructs the image at the time t from the state distribution at the time t, and outputs the image to the identification model MC. The image output from the transition model MA is an image predicted by the transition model MA. On the other hand, the image output from the inference model MB is an image generated by using the actual image.

The identification model MC identifies the reconstruction image input from the transition model MA (also referred to as “derived from the transition model”) and the reconstruction image input from the inference model MB (also referred to as “derived from the inference model”). The identification model MC identifies whether the input image is derived from the transition model or the inference model, and outputs an identification result to a loss calculation unit 21b. A correct answer label indicating whether the input image is an image derived from the transition model or an image derived from the inference model is input to the loss calculation unit 21b. The loss calculation unit 21b outputs, as a loss, an error between the identification result of the identification model MC and the correct answer label to a training unit 22b.

Similar processing is performed for the image at the time t. That is, the transition model MA generates the state distribution at the time t+1 from the object feature amount at the time t, reconstructs the image at the time t+1 from the state distribution, and outputs the image to the identification model MC. The inference model MB generates the state distribution at the time t+1 from the object feature amount at the time t and the actual image at the time t+1, reconstructs the image at the time t+1 from the state distribution, and outputs the image to the identification model MC. The identification model MC identifies whether the input image is derived from the transition model or the inference model, and outputs the identification result to the loss calculation unit 21b. The loss calculation unit 21b outputs, as a loss, an error between the identification result of the identification model MC and the correct answer label to the training unit 22b.

The training unit 22b then updates parameters of the identification model MC in such a way that a sum total of the losses input from the two loss calculation units 21b decreases. Thus, the training of the identification model is performed. Although the description has been made using the two loss calculation units 21b in the above example, in practice, it is only required to input images at times to one loss calculation unit 21b, calculate losses at the times, and output them to the training unit 22b.

In the above example, the training device 100b trains the identification model MC by using the reconstruction images (that is, still images) input from the transition model MA and the inference model MB. Instead, the training device 100b may train the identification model MC based on a series of reconstruction images, that is, moving images, output from the transition model MA and the inference model MB at a plurality of consecutive times. In this case, the loss calculation unit 21b is only required to calculate, as a loss, an error between the moving image output from the transition model MA and the moving image output from the inference model MB.

The training device 100c may train the identification model MC also by using the object feature amounts generated by the transition model MA and the inference model MB instead of the images. Also in this case, the loss calculation unit 21b trains the identification model MC by using, as a loss, an error between the identification result of the identification model MC and the correct answer label. The training device 100c may also train the identification model MC by using the object feature amounts, that is, time-series object feature amounts, output from the transition model MA and the inference model MB at a plurality of consecutive times.

### Third Training Step

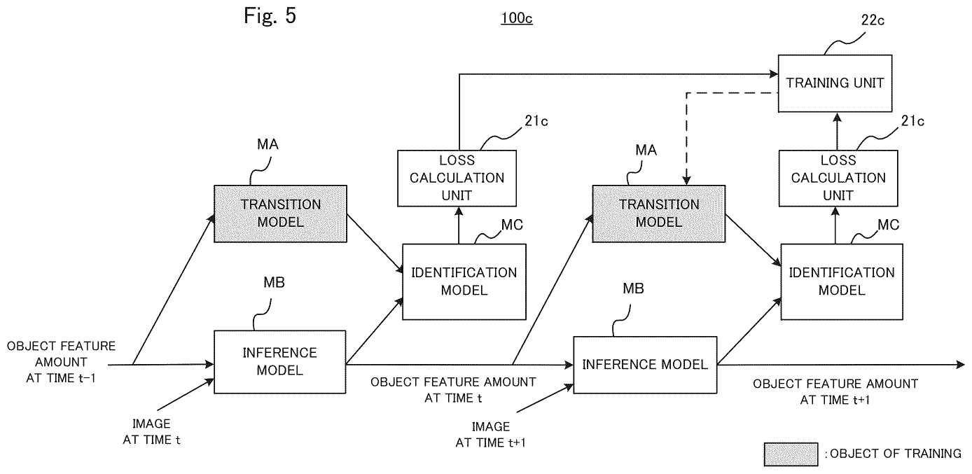

FIG. 5 is a block diagram illustrating a functional configuration of a training device 100c for executing the third training step. In the third training step, the training device 100c retrains the transition model MA trained in the first training step by using the inference model MB trained in the first training step and the identification model MC trained in the second training step. That is, in the third training step, the inference model MB and the identification model MC are not to be trained.

Now, it is assumed that there are time-series input images from a time t−1 to a time t+1. As illustrated in FIG. 5, the object feature amount of each object at the time t−1 is input to the transition model MA and the inference model MB, and the image at the time t is input to the inference model MB. The transition model MA generates the state distribution at the time t from the object feature amount at the time t−1, reconstructs the image at the time t from the state distribution at the time t, and outputs the image to the identification model MC. The inference model MB generates the state distribution at the time t from the object feature amount at the time t−1 and the actual image at the time t, reconstructs the image at the time t from the state distribution at the time t, and outputs the image to the identification model MC. The identification model MC identifies whether the input image is derived from the transition model or the inference model, and outputs an identification result to a loss

A correct answer label indicating whether the input image is an image derived from the transition model or an image derived from the inference model is input to the loss calculation unit 21c. The loss calculation unit 21c calculates a loss based on the identification result of the identification model MC and the correct answer label, and outputs the loss to a training unit 22c. Here, the training unit 22c retrains the transition model MA in such a way that accuracy of the identification by the identification model MC decreases. For example, the loss calculation unit 21c generates, as a loss, a negative value (a value with a minus sign) of an error between the identification result of the identification model MC and the correct answer label or a reciprocal of the error between the identification result of the identification model MC and the correct answer label, and the training unit 22c updates the parameters of the transition model MA in such a way that the loss decreases. Thus, the retraining of the transition model MA is performed.

### Training Processing

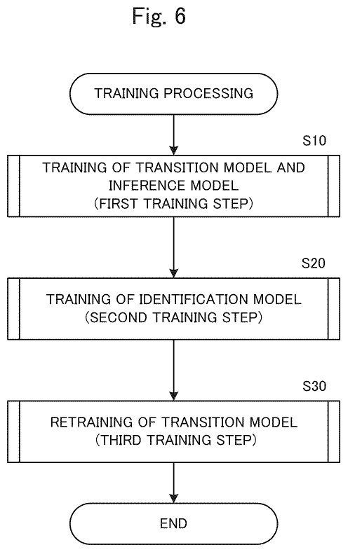

Next, the training processing by the training device 100 will be described. FIG. 6 is a main routine of the training processing by the training device 100. This processing is achieved by the processor 13 illustrated in FIG. 2 executing a program prepared in advance and operating as each element illustrated in FIGS. 3 to 5.

The training processing is performed by the above-described three training steps. First, as the first training step, the training device 100a illustrated in FIG. 3 performs training of the transition model MA and the inference model MB (step S10). Next, as the second training step, the training device 100b illustrated in FIG. 4 performs training of the identification model MC (step S20). Then, as the third training step, the training device 100c illustrated in FIG. 5 performs retraining of the transition model MA (step S30).

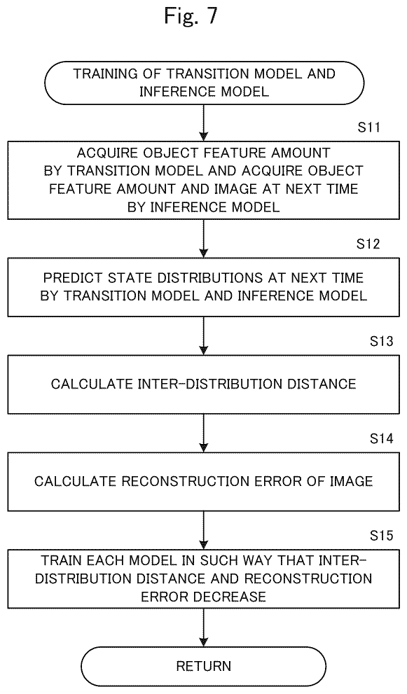

FIG. 7 is a flowchart of the training processing of the transition model and the inference model. First, the transition model MA acquires an object feature amount of each object, and the inference model MB acquires the object feature amount of each object and an image at a next time (step S11). Next, the transition model MA predicts a state distribution at the next time based on the object feature amount, and the inference model MB predicts a state distribution at the next time based on the object feature amount and the image at the next time (step S12). Next, the loss calculation unit 21a calculates an inter-distribution distance between the state distributions output from the transition model MA and the inference model MB (step S13). The loss calculation unit 21a reconstructs the image at the next time from the state distribution output by the inference model MB, and calculates a reconstruction error from the actual image at the next time (step S14). Next, the training unit 22a trains the transition model MA and the inference model MB in such a way that the inter-distribution distance and the reconstruction error decrease (step S15). Then, the processing returns to the main routine in FIG. 6.

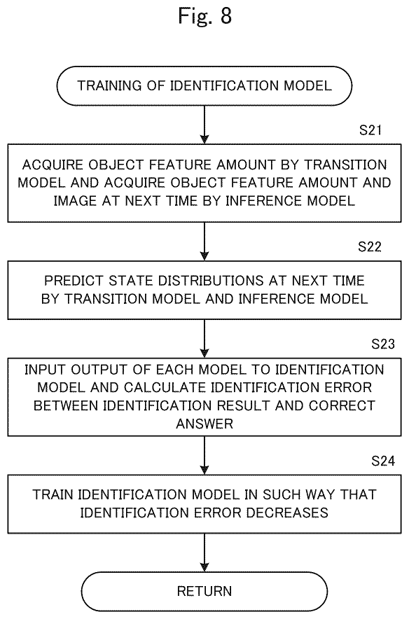

FIG. 8 is a flowchart of the training processing of the identification model. First, the transition model MA acquires the object feature amount of each object, and the inference model MB acquires the object feature amount of each object and the image at the next time (step S21). Next, the transition model MA predicts a state distribution at the next time based on the object feature amount, and the inference model MB predicts a state distribution at the next time based on the object feature amount and the image at the next time (step S22). Next, the transition model MA and the inference model MB output prediction results to the identification model MC. As described above, the prediction results output from the transition model MA and the inference model MB may be still images, moving images, object feature amounts (object center representation), or time-series object feature amounts derived from each model. The identification model MC outputs an identification result to the loss calculation unit 21b. The loss calculation unit 21b calculates an identification error between the identification result by the identification model MC and a correct answer label (step S23). Next, the training unit 22b trains the identification model MC in such a way that the identification error decreases (step S24). Then, the processing returns to the main routine in FIG. 6.

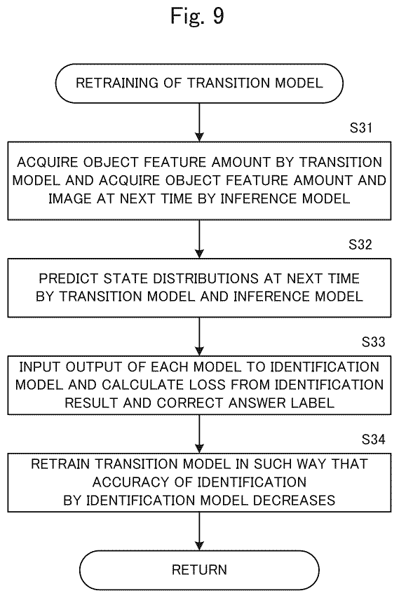

FIG. 9 is a flowchart of the retraining processing of the transition model. First, the transition model MA acquires the object feature amount of each object, and the inference model MB acquires the object feature amount of each object and the image at the next time (step S31). Next, the transition model MA predicts a state distribution at the next time based on the object feature amount, and the inference model MB predicts a state distribution at the next time based on the object feature amount and the image at the next time (step S32). Next, the transition model MA and the inference model MB input prediction results to the identification model MC. As described above, the prediction results output from the transition model MA and the inference model MB may be still images, moving images, object feature amounts (object center representation), or time-series object feature amounts derived from each model. The identification model MC outputs an identification result to the loss calculation unit 21c. The loss calculation unit 21c calculates a loss by using the identification result by the identification model MC and a correct answer label (step S33). Next, the training unit 22c retrains the transition model MA in such a way that accuracy of the identification by the identification model MC decreases (step S34). Then, the processing returns to the main routine in FIG. 6, and the training processing ends.

### Effect

As described above, in the first example embodiment, the identification model MC that identifies an image derived from the transition model and an image derived from the inference model is generated, and the transition model MA is retrained in such a way that the identification by the identification model MC becomes difficult, that is, accuracy of the identification decreases. As a result, the transition model MA can predict a likely image at a certain time as a prediction image at that time. As a result, even in a case where likely future prediction is made in consideration of probabilistic behavior although a prediction result of the transition model MA is different from a result of the inference model MB, it is possible to prevent a transition from being determined to be correct or the result having a strange appearance from being obtained.

### Example of Future Prediction

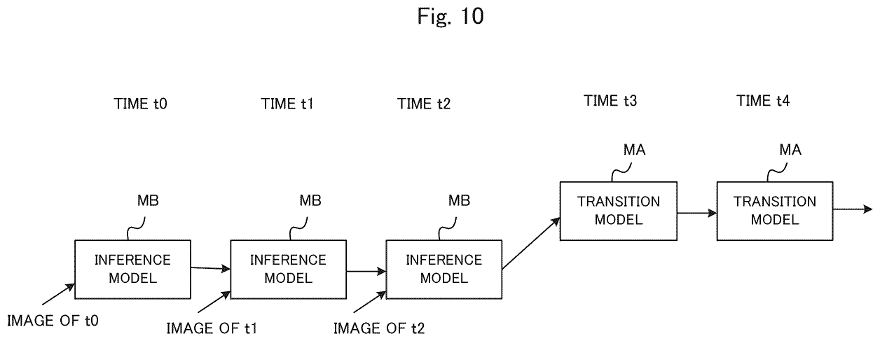

Next, an example of future prediction using the transition model MA and the inference model MB trained by the above training device 100 will be described. FIG. 10 schematically illustrates an example of the future prediction using the transition model MA and the inference model MB.

Now, it is assumed that images from times t0 to t2 are given. In this case, a prediction device predicts states by using the inference model MB at the times t0 to t2 at which the images exist. That is, at the time to, the prediction device inputs the image at the time t0 to the inference model MB. At the time t1, the prediction device inputs, to the inference model MB, an object feature amount of each object at a time t generated by the inference model MB and the actual image at the time t1. At the time t2, the prediction device inputs, to the inference model MB, an object feature amount of each object at the time t1 generated by the inference model MB and the actual image at the time t2.

On the other hand, since there is no actual image after a time t3, the prediction device performs prediction by using the transition model MA. That is, at the time t3, the prediction device inputs, to the transition model MA, an object feature amount of each object at the time t2 generated by the inference model MB. At a time t4, the prediction device inputs, to the transition model MA, an object feature amount of each object at the time t3 generated by the transition model MA. Thus, the future prediction can be performed by using the transition model MA even after the time t3 at which an actual image does not exist.

### Modifications

Next, modifications of the first example embodiment will be described. The following modifications may be applied in appropriate combination.

### First Modification

In the above example embodiment, at the time of training the identification model MC, as illustrated in FIG. 4, the image at each time is input to the identification model MC and the loss is calculated, and the identification model MC is updated. Instead, the training of the identification model MC may be performed by using an image obtained by passing through the transition model MA and the inference model MB a plurality of times at consecutive times.

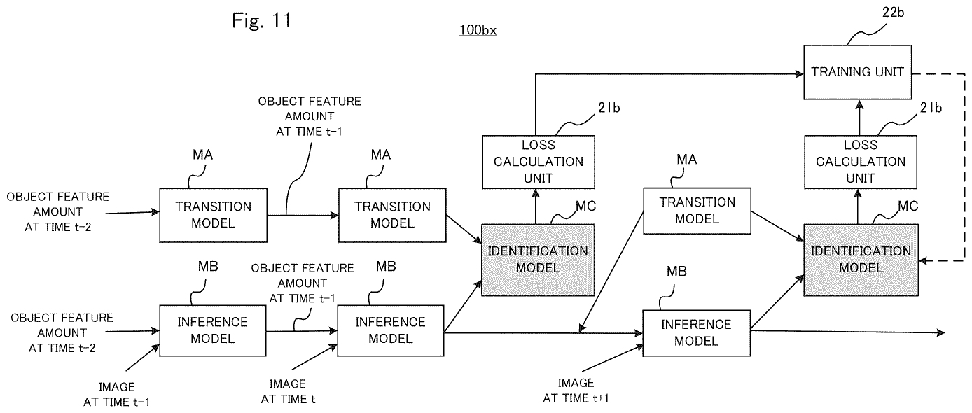

FIG. 11 illustrates a training method of the identification model according to a first modification. As illustrated, an object feature amount of each object at a time t-2 is input to the transition model MA and the inference model MB, object feature amounts output from the transition model MA and the inference model MB are input to the transition model MA and the inference model MB, and reconstruction images output from the transition model MA and the inference model MB are input to the identification model MC. The identification model MC outputs identification results for the reconstruction images of the transition model MA and the inference model MB for the time t, and the loss calculation unit 21b calculates a loss using the identification results. In this manner, the identification model MC may be trained by using a result of continuously passing an object feature amount at a certain time through the transition model MA and the inference model MB a plurality of times.

The reason for performing such processing is as follows. When the transition model MA finally obtained by the training device 100 is actually operated, as described with reference to FIG. 10, it is conceivable to predict a future temporal transition of an object over a plurality of times in a state where there is no actual image. Therefore, according to the above method, it is possible to train the identification model MC in such a way as to accurately identify a result obtained by continuously passing through the transition model MA a plurality of times.

This method can be similarly applied to retraining of the transition model MA after the training of the identification model MC. That is, at the time of retraining the transition model MA, the training device 100c may retrain the transition model MA in such a way that accuracy of identification of the identification model MC decreases by using a result obtained by continuously passing through the transition model MA and the inference model MB a plurality of times.

### Second Modification

In the above training processing, as illustrated in FIG. 6, the first training step to the third training step are performed by using all the prepared input images, and the training processing is ended. Instead, the prepared input images may be divided into predetermined units, and the first to third training steps illustrated in FIG. 6 may be repeated for each unit.

### Third Modification

In the first training step, some action may be input to the transition model MA and the inference model MB. For example, in a case where the above method of the example embodiment is applied to prediction of an environment in which an object is moved by using a robot arm, an action that specifies an operation of the robot arm may be input to the transition model MA and the inference model MB at a certain time. As a result, the transition model MA can predict a future temporal transition in a case where the above action is performed.

### Fourth Modification

In the above example embodiment, the image as the still image or the moving image is input to the transition model MA and the inference model MB. However, the image does not have to be an image captured by a normal camera, and may be data generated by a sensor or the like. For example, a distance image measured by using a depth camera, point cloud data generated by using LiDAR, and the like can also be used as the input image in the present example embodiment.

Auxiliary data may be input to the transition model MA and the inference model MB in addition to the image. For example, audio data collected by a microphone, output data of a sensor such as a weight sensor or a pressure sensor, and the like may be input to the transition model MA and the inference model MB together with the image. In this case, two methods of using the auxiliary data are conceivable. In a first method, the auxiliary data may be used as an object of transition prediction similarly to the image described above. That is, in the first training step, the training device 100a may calculate an inter-distribution distance between state distributions and a reconstruction error for the auxiliary data in addition to the image, and train the transition model MA and the inference model MB. On the other hand, in a second method, the auxiliary data is not the object of the transition prediction, and may be used as auxiliary data only for the transition prediction of the image. In this case, the auxiliary data may be handled similarly to the action in the above third modification in the transition prediction.

### Application Example

The above example embodiment can be applied to fields of medical care and healthcare. For example, the above example embodiment can be applied to transition prediction and control of a medical robot that assists an operation of a patient and the like. In this case, the medical robot grasps an environment in an operation room, a physical condition of the patient, instruments and procedures necessary for the operation, and the like by using the transition model MA and the inference model MB (hereinafter, referred to as the “world models”) trained by the training device 100 of the example embodiment. Specifically, the medical robot can grasp an internal state of the patient in real time based on information obtained from a camera and a sensor, and can select the instruments necessary for the operation and adjust the procedures.

An example of specific processing in a case where an operation robot is used as the medical robot is as follows.
(1) The operation robot includes a camera and a sensor, and grasps an internal state of a patient's body, positions of instruments and procedures necessary for an operation, and the like in real time.
(2) The world models trained according to the example embodiment provide information necessary during the operation based on the information grasped by the operation robot.
(3) The operation robot selects the instruments necessary for the operation and adjusts the procedures based on the information provided from the trained world models.

As a result, the operation robot using the world models can work together with a doctor or a nurse. The operation robot can autonomously operate in cooperation with the doctor or the nurse by using the world models capable of predicting movement of the doctor or the nurse. The operation robot can perform the operation with minimum invasion by accurately recognizing a state of the patient by using the prediction model.

### Second Example Embodiment

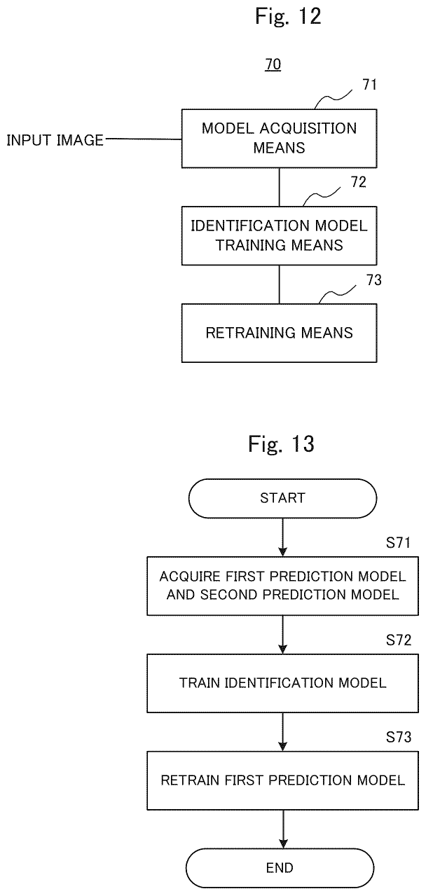

FIG. 12 is a block diagram illustrating a configuration of a training device according to a second example embodiment. A training device 70 according to the second example embodiment includes model acquisition means 71, identification model training means 72, and retraining means 73.

FIG. 13 is a flowchart of processing by the training device 70 according to the second example embodiment. The model acquisition means 71 acquires a first prediction model that generates a first prediction feature amount indicating a state of each object at a next time based on an input object feature amount, and a second prediction model that generates a second prediction feature amount indicating a state of each object at the next time based on the input object feature amount and an image at the next time (step S71). The identification model training means 72 trains an identification model that identifies an output from the first prediction model and an output from the second prediction model (step S72). The retraining means 73 retrains the first prediction model in such a way that accuracy of the identification by the identification model decreases (step S73).

According to the training device 70 of the second example embodiment, it is possible to train a model capable of predicting a likely temporal transition.

Some or all of the example embodiments described above may also be described as the following Supplementary notes, but not limited thereto.

### Supplementary Note 1

A training device comprising:
model acquisition means configured to acquire a first prediction model that generates a first prediction feature amount indicating a state of each object at a next time based on an input object feature amount, and a second prediction model that generates a second prediction feature amount indicating a state of each object at the next time based on the input object feature amount and an image at the next time;
identification model training means configured to train an identification model that identifies an output from the first prediction model and an output from the second prediction model; and
retraining means configured to retrain the first prediction model in such a way that accuracy of the identification by the identification model decreases.

### Supplementary Note 2

The training device according to claim 1, wherein the identification model training means trains the identification model by using the first prediction feature amount and the second prediction feature amount.

### Supplementary Note 3

The training device according to Supplementary note 1, wherein the identification model training means trains the identification model by using a first prediction image reconstructed from the first prediction feature amount and a second prediction image reconstructed from the second prediction feature amount.

### Supplementary Note 4

The training device according to Supplementary note 1, wherein the identification model training means trains the identification model by using the first prediction feature amount output from the first prediction model after repeatedly performing prediction a plurality of times and the second prediction feature amount output from the second prediction model after repeatedly performing prediction the plurality of times.

### Supplementary Note 5

The training device according to Supplementary note 1, wherein the retraining means retrains the first prediction model in such a way as to decrease accuracy of identification by the identification model between the first prediction feature amount output from the first prediction model after repeatedly performing prediction a plurality of times and the second prediction feature amount output from the second prediction model after repeatedly performing prediction the plurality of times.

### Supplementary Note 6

The training device according to Supplementary note 1,
wherein the first prediction model predicts a first state distribution of each object at the next time and generates the first prediction feature amount based on the first state distribution, and
wherein the second prediction model predicts a second state distribution of each object at the next time and generates the second prediction feature amount based on the second state distribution.

### Supplementary Note 7

The training device according to Supplementary note 6, further comprising prediction model training means configured to train the first prediction model and the second prediction model,
wherein the prediction model training means trains the first prediction model and the second prediction model in such a way that a distance between the first state distribution and the second state distribution decreases and an error between an image reconstructed from the second prediction feature amount and the actual image at the next time decreases, and
wherein the model acquisition means acquires the first prediction model and the second prediction model trained by the prediction model training means.

### Supplementary Note 8

The training device according to Supplementary note 1,
wherein the object includes a patient and a medical instrument,
wherein the first prediction model outputs the first prediction feature amount indicating states of the patient and the medical instrument at the next time, and
wherein the second prediction model outputs the second prediction feature amount indicating states of the patient and the medical instrument at the next time.

### Supplementary Note 9

A training method executed by a computer, comprising:
acquiring a first prediction model that generates a first prediction feature amount indicating a state of each object at a next time based on an input object feature amount, and a second prediction model that generates a second prediction feature amount indicating a state of each object at the next time based on the input object feature amount and an image at the next time;
training an identification model that identifies an output from the first prediction model and an output from the second prediction model; and
retraining the first prediction model in such a way that accuracy of the identification by the identification model decreases.

### Supplementary Note 10

A recording medium recording a program for causing a computer to execute processing comprising:
acquiring a first prediction model that generates a first prediction feature amount indicating a state of each object at a next time based on an input object feature amount, and a second prediction model that generates a second prediction feature amount indicating a state of each object at the next time based on the input object feature amount and an image at the next time;
training an identification model that identifies an output from the first prediction model and an output from the second prediction model; and
retraining the first prediction model in such a way that accuracy of the identification by the identification model decreases.

While the present invention has been described with reference to the embodiments, the present invention is not limited to the above example embodiments. Various changes that can be understood by those skilled in the art within the scope of the present invention can be made in the configuration and details of the present invention.

### DESCRIPTION OF SYMBOLS

13 Processor
21a, 21b, 21c Loss calculation unit
22a, 22b, 22c Training unit
100a, 100b, 100c Training device
MA Transition model
MB Inference model
MC Identification model

What is claimed is:

1. A training device comprising:
a memory configured to store instructions; and
a processor configured to execute the instructions to:
acquire a first prediction model that generates a first prediction feature amount indicating a state of each object at a next time based on an input object feature amount, and a second prediction model that generates a second prediction feature amount indicating a state of each object at the next time based on the input object feature amount and an image at the next time;
train an identification model that identifies an output from the first prediction model and an output from the second prediction model; and
retrain the first prediction model in such a way that accuracy of the identification by the identification model decreases.

2. The training device according to claim 1, wherein the processor trains the identification model by using the first prediction feature amount and the second prediction feature amount.

3. The training device according to claim 1, wherein the processor trains the identification model by using a first prediction image reconstructed from the first prediction feature amount and a second prediction image reconstructed from the second prediction feature amount.

4. The training device according to claim 1, wherein the processor trains the identification model by using the first prediction feature amount output from the first prediction model after repeatedly performing prediction a plurality of times and the second prediction feature amount output from the second prediction model after repeatedly performing prediction the plurality of times.

5. The training device according to claim 1, wherein the processor retrains the first prediction model in such a way as to decrease accuracy of identification by the identification model between the first prediction feature amount output from the first prediction model after repeatedly performing prediction a plurality of times and the second prediction feature amount output from the second prediction model after repeatedly performing prediction the plurality of times.

6. The training device according to claim 1,
wherein the first prediction model predicts a first state distribution of each object at the next time and generates the first prediction feature amount based on the first state distribution, and
wherein the second prediction model predicts a second state distribution of each object at the next time and generates the second prediction feature amount based on the second state distribution.

7. The training device according to claim 6,
wherein the processor configured to further execute the instructions to train the first prediction model and the second prediction model,
wherein the processor trains the first prediction model and the second prediction model in such a way that a distance between the first state distribution and the second state distribution decreases and an error between an image reconstructed from the second prediction feature amount and the actual image at the next time decreases, and
wherein the processor acquires the trained first prediction model and the trained second prediction model.

8. The training device according to claim 1,
wherein the object includes a patient and a medical instrument,
wherein the first prediction model outputs the first prediction feature amount indicating states of the patient and the medical instrument at the next time, and
wherein the second prediction model outputs the second prediction feature amount indicating states of the patient and the medical instrument at the next time.

9. A training method executed by a computer, comprising:
acquiring a first prediction model that generates a first prediction feature amount indicating a state of each object at a next time based on an input object feature amount, and a second prediction model that generates a second prediction feature amount indicating a state of each object at the next time based on the input object feature amount and an image at the next time;
training an identification model that identifies an output from the first prediction model and an output from the second prediction model; and
retraining the first prediction model in such a way that accuracy of the identification by the identification model decreases.

10. A non-transitory computer-readable recording medium recording a program for causing a computer to execute processing comprising:
acquiring a first prediction model that generates a first prediction feature amount indicating a state of each object at a next time based on an input object feature amount, and a second prediction model that generates a second prediction feature amount indicating a state of each object at the next time based on the input object feature amount and an image at the next time;
training an identification model that identifies an output from the first prediction model and an output from the second prediction model; and
retraining the first prediction model in such a way that accuracy of the identification by the identification model decreases.
